(19) United States
(12) Patent Application Publication
(10) Pub. No.: US 2026/0203407 A1
(43) Pub. Date: Jul. 16, 2026

(54) System and method for detecting and mitigating malware threats by creating threat detection policies based on threat metadata

(71) Applicant: Bank of America Corporation, Charlotte, NC (US)

(72) Inventors: Varun Vidyadharan Ezhava, Hyderabad (IN); Naveen Reddy Mamidi, Hyderabad (IN); Maneesh Kumar Sethia, Hyderabad (IN); Rahul Pabolu, Hyderabad (IN); Prakruti Pathwar, Noida (IN)

(21) Appl. No.: 19/026,039

(22) Filed: Jan. 16, 2025

(51) Int. Cl. G06F 21/56; G06F 16/951

(52) U.S. Cl. CPC G06F 21/568; G06F 16/951; G06F 21/563; G06F 2221/033

(57) ABSTRACT

A system for improved protection of network devices from malware threats using the generative AI model includes a memory operably coupled with a processor. The processor is configured to receive threat metadata from a web crawler configured to access one or more websites. The processor is further configured to execute the generative AI model using the threat metadata as input. The generative AI model is configured to generate a threat definition as an output. The processor is further configured to identify, based on the scan, a threat associated with a suspected software program before it executes a malicious software code on one or more organizational resources, wherein the malicious software code of the suspected software program matches the software code of the threat definition. The processor is further configured to mitigate the identified threat.

### TECHNICAL FIELD

The present disclosure relates generally to malware threat detection, and more specifically to a system and method for detecting and mitigating malware threats by creating threat detection policies based on threat metadata.

### BACKGROUND

The current malware detection techniques are not configured to identify malware threats before an attack. In one example, a malware attack on an organizational resource (e.g., a data server) of an organization may result in a data breach that is detected after the attack has performed the data breach. The data breach may include an unauthorized installation of a malicious software program on an organizational resource. Further, the malicious software program performs malicious activities to disrupt the operation of the organizational resource by creating unwanted files to slow down the speed and performance of the organizational resource, corrupting files, or crashing some software or executable applications so that they cannot be executed. Current malware detection techniques lack the capability to detect malware threats before an attack and apply security measures that avoid or prevent the malware attack from causing damage to the organizational resource.

### SUMMARY

The disclosed system, described in the present disclosure, is particularly integrated into a practical application for improved protection of organizational resources from malware threats. This practical application provides several technical advantages, including utilizing a generative artificial intelligence (AI) model that dynamically adapts to new and emerging malware threats identified by collecting information about emerging malware threats from the public Internet and proactively scanning organizational resources to detect and mitigate them before they attack the organizational resources. The organizational resources that may be protected by the system of the present disclosure include hardware, such as mainframes, servers, networking equipment, computers, mobile devices, memory devices, and the like; software that is executed by the hardware; and/or information stored or operated upon by the hardware or software.

The current malware detection techniques are not configured to identify new types of malware threats before an attack. Specifically, the current malware detection techniques are retroactive – meaning that after the attack has done its intended damage to organizational resources, the malware is detected and addressed. The current malware detection techniques suffer from several drawbacks. For example, because the current malware detection techniques are retroactive, the security of organizational resources and information stored in the organizational resources is already compromised by the attack.

The disclosed system provides a technical solution to these and other technical problems in the realm of malware detection. The disclosed system improves the protection of organizational resources from malware by proactively detecting malware on organizational resources using a generative AI model. A web crawler device collects information by analyzing public Internet, such as websites (e.g., blogs or technical forum discussions) associated with discussions for a new type of malware that may be developed by bad actors and that would, if implemented, present vulnerabilities to organizational resources. By way of example, the information collected may include a malicious operation pattern implemented by a malicious software program. The malicious operation pattern is an operation pattern associated with how the malicious software program (e.g., Virus A) conducts an attack. This information collected by the web crawler device is referred to as threat metadata. The generative AI model receives threat metadata from the web crawler device, wherein this threat metadata includes malicious operation patterns that are conducted by a potential malicious software program (e.g., Virus A). Threat metadata is input to the generative AI model. The generative AI model creates threat definitions as output.

Threat definitions include a software code associated with the malicious operation pattern of the malicious software program. For example, this software code is an executable software program code that corresponds to the malicious operation pattern conducted by the potential malicious software program. The generative AI model stores the threat definitions in a threat definitions database. The disclosed system scans the organizational resources for malware substantially corresponding to the stored threat definitions. In response to the scan, the disclosed system identifies that a device that is part of the organizational resources includes a suspected software program that includes a malicious software code that at least partially matches the stored software code associated with the threat definition. Thus, the disclosed system identifies the suspected software program as a threat before the malicious software code is executed. Upon identifying the suspected software program as a threat, mitigation of the identified threat is performed by quarantining the suspected software program before the suspected software program executes the malicious software code.

As part of quarantining the suspected software program, the disclosed system transfers the suspected software program from the device where it was identified to a quarantine sector within the memory of a threat evaluation device. A quarantine sector is a memory sector created by the disclosed system such that software programs, software applications, or any files stored in this quarantine sector are not permitted or prevented from acting on files outside the quarantine sector. Thus, any malicious file isolated in the quarantine sector cannot harm or attack the rest of the components outside the quarantine sector. Further, the disclosed system may transfer the suspected software program by first copying the suspected software program into the quarantine sector and then deleting the suspected software program from the device where it was identified. Once the suspected software program is transferred into the quarantine sector, the disclosed system mitigates the identified threat by deleting the malicious software code from the suspected software program to generate a sanitized version of the suspected software program. The sanitized version of the suspected software program is then transferred back to the device where the suspected software program was identified. In this manner, malware attacks are mitigated by physically isolating the suspected software program on to the quarantine sector and proactively deleting the malicious software code from that suspected software program to create a sanitized version of the suspected software program as a new software program. Thus, by mitigating malware attacks before an attack takes place, the security of the organizational resources and information stored in the organizational resources is not compromised. Accordingly, the disclosed system provides a practical application and technical improvement for proactively detecting malware threats and addresses and mitigating the malware threats before the suspected software program executes the malicious software code has a chance to infect the organizational resources over the current malware detection technology that is not configured to identify new types of malware before an attack.

The current malware detection techniques are based on predetermined policies that may not catch new or sophisticated malware attacks that deviate from recognized malware attack patterns. In contrast, the disclosed system is configured to identify new malware by periodically gathering new malware threat information from the public Internet, such as websites (e.g., blogs or technical forum discussions), and identify attack patterns associated with the new malware that would not necessarily trigger current malware detection techniques before the malware attack.

In current malware detection techniques, when organizational resources are affected by a malware attack, the attack performs harmful actions, such as system damage. System damage occurs when the malware deletes data or modifies a code of the organizational resource, leading to unstable or unusable systems. Another example of harmful action is data exfiltration. Data exfiltration occurs when the malware steals sensitive information (such as emails, passwords, financial information, etc.) stored in organizational resources. To remedy such harmful actions (i.e., system damage and data exfiltration), the affected organizational resource must be taken offline until the root problem is identified, thus making it inaccessible until the problem is identified and remedied. Thus, the disclosed system provides a technical solution for identifying and mitigating the malicious software code associated with performing the system damage before the attack. Accordingly, by deleting the malicious software code before the attack, the harmful action of system damage is evaded, thus saving downtime associated with affected organizational resources and additionally saving resources that would otherwise be necessary to remediate affected organizational resources, which in turn provides uninterrupted operations of the organization. This leads to improved operational efficiency of organizational resources because the organizational resources are not required to be taken offline for remediation. Other examples of harmful actions that the disclosed system is able to evade before an attack may include service disruption of the organization's resources, data espionage, and identity theft.

In current malware detection techniques, when organizational resources are attacked by a new type of malware, it could take a network administrator hours or days to determine the root problem and provide a solution. At the same time, the organizational resources could be inaccessible until the problem is identified. Thus, the disclosed system provides a technical solution of communicating a warning message to a network administrator; the warning message alerts the network administrator that a malware attack is detected and is being mitigated. The warning message may also include information identifying the portion of the suspected hardware, software, or information that is affected by the malware attack and how the malware attack is being mitigated. The disclosed system provides technical solutions to certain technical problems of current malware detection techniques by communicating a warning message to a network administrator for attacks from the new type of malware rather than current malware detection techniques that are not configured to transmit any notification before an attack.

In some embodiments, in response to detecting a malware threat on a first device that is part of the organizational resources, the disclosed system scans for the detected malware on other organizational resources that have been in communication with the first device. For example, assuming that the malware threat is detected within a file attached to a spam email sent by a first device to other organizational resources within an organization, the disclosed system of the disclosed system may proactively scan for the detected malware on the other organizational resources that received the spam email. This provides a technical improvement in proactively searching for evidence of the malware across multiple computing devices over the current malware detection techniques where the malware would not have been identified before the attack. In response to determining the malware threat on the other organizational resources in communication with the first device, the disclosed system may proactively mitigate the malware threat similar to how the mitigation techniques are used to mitigate the attack on the first device.

In this manner, the disclosed system improves the accuracy of malware threat detections and mitigations, especially against emerging new malware attack techniques and patterns. The disclosed system is in an ongoing process of identifying new types of malware attacks and mitigating these attacks before the organizational resources are compromised, which improves the efficiency of the disclosed system.

In some embodiments, a system for improved protection of network devices from malware threats using the generative AI model includes a memory operably coupled with a processor. The memory is configured to store a generative artificial intelligence (AI) model and a threat definitions database. The processor is configured to receive threat metadata from a web crawler configured to access one or more websites, wherein the threat metadata is associated with a malicious software program that implements a malicious operation pattern. The processor is further configured to execute the generative AI model using the threat metadata as an input. The generative AI model is configured to generate a threat definition as output, wherein the threat definition includes software code associated with the malicious operation pattern of the malicious software program. The generative AI model is further configured to store the threat definition in the threat definitions database. The processor is further configured to perform a scan of one or more organizational resources based on the stored threat definition. The processor is further configured to identify, based on the scan, a threat associated with a suspected software program before it executes a malicious software code on the one or more organizational resources, wherein the malicious software code of the suspected software program matches the software code of the threat definition. The processor is further configured to mitigate the identified threat by quarantining the suspected software program before it executes the malicious software code on the one or more organizational resources.

Some embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment of a system for detecting and mitigating malware threats by creating threat definitions based on threat metadata;

FIG. 2 illustrates one embodiment of a threat definitions database of the system of FIG.1; and

FIG. 3 illustrates an example flowchart of a method of the system of FIG. 1 for detecting and mitigating malware threats by creating threat definitions based on threat metadata.

### DETAILED DESCRIPTION

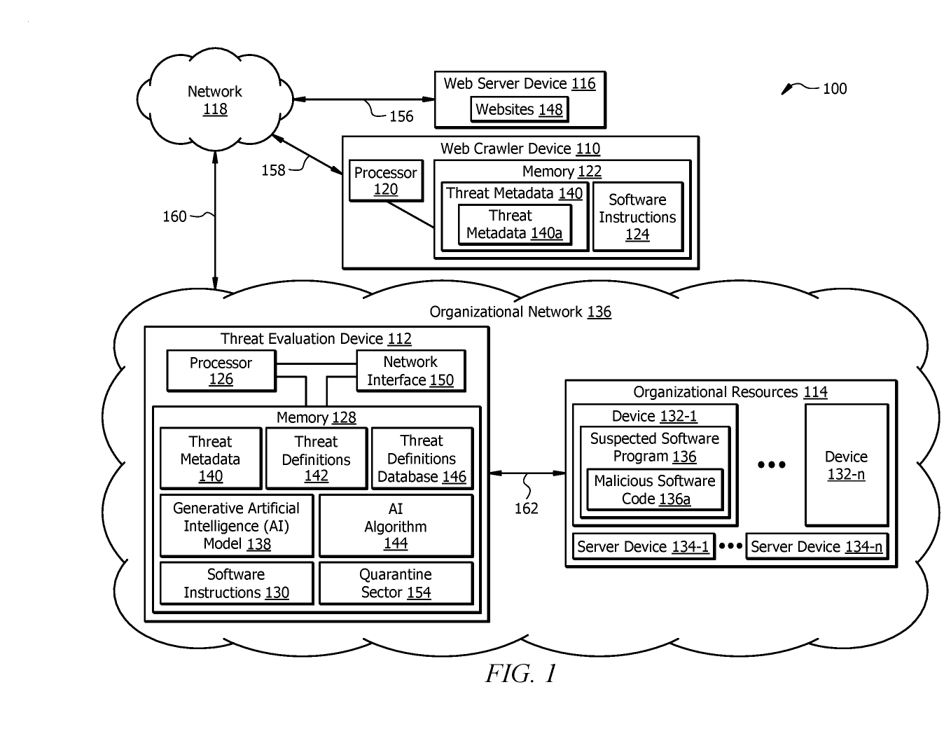

As described above, previous technologies fail to identify new types of malware threats before an attack. Embodiments of the present disclosure and its advantages may be understood by referring to FIGS. 1 through 3. FIGS. 1 through 3 are used to describe systems and methods for detecting and mitigating malware threats by creating threat definitions based on threat metadata before an attack, according to some embodiments.

### System overview

FIG. 1 is a schematic diagram of a system 100, in accordance with certain aspects of the present disclosure. As shown, system 100 includes a web crawler device 110, a threat evaluation device 112, organizational resources 114, and a web server device 116, operably connected to one another via a network 118. Network 118 enables communication among the components of the system 100. In other embodiments, system 100 may include other elements instead of, or in addition to, those listed above.

In general, system 100 improves the protection of organizational resources 114 from malware threats by proactively detecting malware threats using a generative AI model 138 stored in the memory 128 of the threat evaluation device 112. Web crawler device 110 collects threat metadata 140 by analyzing public Internet, such as websites 148 stored at web server device 116. These websites 148 may include news websites, blogs, or technical forum discussions associated with discussions for a new type of malware that may be developed by bad actors and that would, if implemented, present vulnerabilities to organizational resources 114.

By way of example, the threat metadata 140 collected may include threat metadata 140a, which is a malicious operation pattern implemented by a malicious software program (e.g., Virus A). The malicious operation pattern in the threat metadata 140a is an operation pattern associated with how Virus A conducts an attack. The processor 126 receives threat metadata 140 (e.g., threat metadata 140a) from the web crawler device 110 and stores it in memory 128. The processor 126 executes the generative AI model 138, such that when threat metadata 140 is input to the generative AI model 138, the generative AI model 138 creates threat definitions 142 as output. For example, when threat metadata 140a is input to the generative AI model 138, then the output is the threat definition 142a.

Threat definitions 142 include a software code associated with the malicious operation pattern of the malicious software program. For example, threat definition 142a is a software code that corresponds to the malicious operation pattern conducted by Virus A. The generative AI model 138 stores the threat definitions 142 in a threat definitions database 146. For example, threat definitions database 146 includes a table representing the threat metadata 140a-140n and its corresponding threat definitions 140a-140-n. For example, threat definitions database 146 shows a threat metadata 140a that includes the malicious operation pattern of Virus A when inputted to the generative AI model 138, and the corresponding threat definition 142a was created as output. The threat definition 142a is the software code associated with the malicious operation pattern of Virus A.

Once the threat definitions 142 are stored in the threat definitions database 146, the processor 126 scans the organizational resources 114 for malware corresponding to the stored threat definitions 142. In response to the scan, processor 126 identifies that the device 132-1 includes a suspected software program 136, which includes a malicious software code 136a that at least partially matches the software code associated with Virus A included in the threat definition 142a. Thus, processor 126 identifies suspected software program 136 as a threat before the malicious software code 136a executes its malicious operation. Upon identifying the suspected software program 136 as a threat, mitigation of the identified threat is performed by quarantining the suspected software program 136 before the suspected software program 136 executes the malicious software code 136a. As part of quarantining the suspected software program 136, the suspected software program 136 is transferred from device 132-1 to quarantine sector 154 within memory 128 of the threat evaluation device 112. Quarantine sector 154 is a sector of the memory 128 created by the disclosed system such that suspected software program 136, when stored in this quarantine sector 154, is not permitted or prevented from performing any operation on files outside the quarantine sector 154. Specifically, the malicious software code 136a, when in the quarantine sector 154 is prevented from performing any write or read actions outside the quarantine sector 154. Thus, the suspected software program 136 in the quarantine sector 154 is isolated from the rest of the memory 128. When suspected software program 136 is in the quarantine sector 154, it cannot harm or attack the rest of the components outside the quarantine sector 154. Further, the transfer is performed by the processor 126 copying the suspected software program 136 into the quarantine sector 154 and then deleting the suspected software program 136 from the device 132-1 where it was identified. Once the suspected software program 136 is transferred into the quarantine sector 154, the disclosed system mitigates the identified threat by deleting the malicious software code 136a from the suspected software program 136 to generate a sanitized version of the suspected software program 136. The sanitized version of the suspected software program 136 without the malicious software code 136a is then transferred back to device 132-1, where the suspected software program 136 was identified. Alternatively, upon identifying the suspected software program 136 as a threat, mitigation of the identified threat is performed by deleting the malicious software code 136a from the suspected software program 136 before the suspected software program 136 executes the malicious software code 136a on organizational resources 114. Further, if it is determined that the malicious software code 136a cannot be deleted, then the suspected software program 136 is quarantined.

In this manner, by physically isolating the suspected software program on to the quarantine sector and proactively deleting the malicious software code from that suspected software program to create a sanitized version of the suspected software program to mitigate malware attack, the security of the organizational resources and information stored in the organizational resources is not compromised. Accordingly, system 100 provides a practical application and technical improvement for proactively detecting malware threats and addresses and mitigates the malware threats before the malware has a chance to infect the device 132-1 over the current malware detection technology that is not configured to identify new types of malware before an attack actually occurs.

### SYSTEM COMPONENTS

### Network

Network 118 may be any suitable type of wireless and/or wired network. The network 118 may be connected to the Internet or public network. The network 118 may include all or a portion of an Intranet, a peer-to-peer network, a switched telephone network, a local area network (LAN), a wide area network (WAN), a metropolitan area network (MAN), a personal area network (PAN), a wireless PAN (WPAN), an overlay network, a software-defined network (SDN), a virtual private network (VPN), a mobile telephone network (e.g., cellular networks, such as 4G or 5G), a plain old telephone (POT) network, a wireless data network (e.g., Wireless Fidelity (WiFi®), Wireless Gigabit (WiGig®), Worldwide Interoperability for Microwave Access (WiMAX®), etc.), a long-term evolution (LTE) network, a universal mobile telecommunications system (UMTS) network, a peer-to-peer (P2P) network, a Bluetooth® network, a near-field communication (NFC) network, and/or any other suitable network. The network 118 may be configured to support any suitable type of communication protocol, as would be appreciated by one of ordinary skills in the art.

### Web Server device

Web server device 116 represents any server device that stores websites 148 accessible over the public Internet. By way of example, the websites 148 stored at the web server device 116 may include (i) news provider websites (such as, for example, Google News®, Yahoo! News®, CNN®, an Associated Press® feed, a Reuters® feed, etc.); (ii) a social networking site (such as, for example, Facebook®, Instagram®, Reddit®, Github®, Myspace®, LinkedIn® and/or Twitter®), although any other website may also be included. These websites represent data sources for the web crawler device 110 for collecting information associated with new types of malware attacks (explained in detail below).

### Web crawler device and Threat metadata

The web crawler device 110 includes a processor 120 in signal communication with a memory 122. Memory 122 stores software instructions 124 that, when executed by the processor 120, cause processor 120 to perform one or more operations of the web crawler device 110 described herein. Memory 122 is configured to store software instructions 124 to perform operations of collecting information associated with new types of malware attacks. For example, web crawler device 110 searches the public Internet (via the network 118), such as websites 148 (e.g., news, blogs, or technical forum discussions) associated with discussions for a new type of malware that may be developed by bad actors and that would, if implemented, present vulnerabilities to organizational resources 114. The web crawler device 110 is programmed to periodically search websites 148 stored at web server device 116 for malware attack topics based on keywords corresponding to a malware attack. For example, the keywords may include “virus,” “malware,” “trojan horse,” “macro virus,” “ransomware,” “spyware,” “adware,” “scareware,” or “rootkit.” although any other keyword may also be utilized that related to malware attacks. The web crawler device 110 may identify a relevant website within the websites 148 (e.g., news, blogs, or technical forum discussions) at web server device 116 based on the search. Upon identifying the relevant website, the web crawler device 110 analyzes it to determine information related to the operation pattern associated with the malware attack in discussion within the relevant website and generates a summarized representation of the operation pattern associated with the malware attack. This summarized representation of the operation pattern is referred to as threat metadata 140. The web crawler device 110 then transmits the generated threat metadata 140 to the threat evaluation device 112 in the organizational network 136.

In another embodiment, the web crawler device 110 may be part of the organizational network 136, and the web crawler device 110 transmits the generated threat metadata 140 to the threat evaluation device 112 internally within the organizational network 136.

### Organizational network

The organizational network 136 includes organizational resources 114 and threat evaluation device 112. The organizational network 136 is in communication with the web crawler device 110 and the web server device 116 via the network 118. In some embodiments, the organizational network 136 may be an internal network of the organization and may include all or a portion of a private data network, a local area network (LAN), a metropolitan area network (MAN), a wide area network (WAN), a local or regional communication or computer network, a wireline or wireless network, an enterprise intranet, or any other suitable communication link, including combinations thereof, operable to facilitate communication between threat evaluation device 112 and organizational resources 114.

### Organizational resources

The organizational resources 114 include devices 132-1 to 132-n and server devices 134-1 to 134-n. Devices 132-1 to 132-n and server devices 134-1 to 134-n located in the organizational network 136 of an organization. The devices 132-1 to 132-n may generally be any device that is configured to process data. The organizational resources 114 that may be protected by the system 100 of the present disclosure include hardware, such as mainframes, servers, networking equipment, computers, mobile devices, memory devices, and the like; software that is executed by the hardware; and/or information stored or operated upon by the hardware or software. Additionally, devices 132-1 to 132-n may also include, but are not limited to, a personal computer, a desktop computer, a workstation, a server, a laptop, a tablet computer, a mobile phone (such as a smartphone), an Internet-of-Things (IoT) device, or any other suitable type of device. The devices 132-1 to 132-n may include a user interface, such as a display, a microphone, a camera, a keypad, or other appropriate terminal equipment usable by a user. Server devices 134-1 to 134-n may be database servers, application servers, or any other server devices utilized within an organization.

### Threat evaluation device

The threat evaluation device 112 includes a processor 126 in signal communication with a memory 128. Memory 128 stores software instructions 130 that, when executed by processor 126, cause processor 126 to perform operations of the threat evaluation device 112. The operations performed by the processor 126 include proactively detecting new and emerging malware threats and mitigating the emerging malware threats before an attack. In some embodiments, the threat evaluation device 112 may be implemented by a cluster of computing devices, such as virtual machines. For example, the threat evaluation device 112 may be implemented by a plurality of computing devices using distributed computing and/or cloud computing systems in a network. In some embodiments, the threat evaluation device 112 may be one or more servers in a server farm. In some embodiments, the threat evaluation device 112 may include one or more servers in one or more data centers, data warehouses, and the like. The threat evaluation device 112 may be an instance of one or more servers. In some embodiments, the threat evaluation device 112 may be configured to provide services and resources (e.g., data and/or hardware resources) to the components of the system 100. The threat evaluation device 112 (e.g., via the generative AI model 138) may generate threat definitions 142 based on stored threat metadata 140. Processor 126 of the threat evaluation device 112 is configured to scan the organizational resources 114 to identify any malware threats, for example, suspected software program 136 in device 132-1. In some embodiments, the threat evaluation device 112 and the organizational resources 114 are part of an organizational network 136 of an organization. In another embodiment, the organizational network 136 is an internal network of the organization. In another embodiment, the threat evaluation device 112 may be external to the organizational network 136. In yet another embodiment, the organizational resources 114 may be external to the organizational network 136 of the organization. Further, in response to detecting the malware threat, the processor 126 of the threat evaluation device 112 performs operations of mitigating the malware threat.

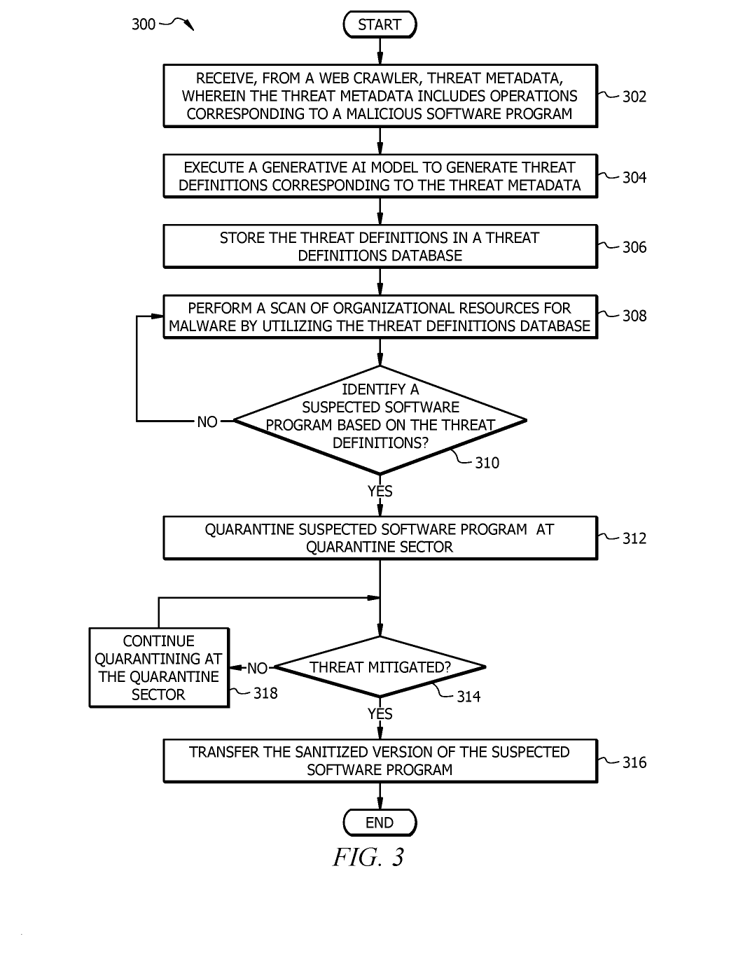

The threat evaluation device 112 includes a processor 126 operably coupled with a memory 128 and a network interface 150. Processor 126 includes one or more processors. The processor 126 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). For example, one or more processors may be implemented in cloud devices, servers, virtual machines, and the like. The processor 126 may be a programmable logic device, a microcontroller, a microprocessor, or any suitable number and combination of the preceding. The one or more processors are configured to process data and may be implemented in hardware or software. For example, the processor 126 may be 8-bit, 16-bit, 32-bit, 64-bit, or of any other suitable architecture. The processor 126 may include an arithmetic logic unit (ALU) for performing arithmetic and logic operations. The processor 126 may register the supply operands to the ALU and store the results of ALU operations. The processor 126 may further include a control unit that fetches instructions from memory and executes them by directing the coordinated operations of the ALU, registers, and other components. The one or more processors are configured to implement various software instructions. For example, the one or more processors are configured to execute instructions (e.g., software instructions 130) to perform the operations of the threat evaluation device 112 described herein. In this way, processor 126 may be a special-purpose computer designed to implement the functions disclosed herein. In an embodiment, the processor 126 is implemented using logic units, FPGAs, ASICs, DSPs, or any other suitable hardware. The processor 126 is configured to operate as described in FIGS. 1-3. For example, the processor 126 may be configured to perform one or more operations of the method 300 as described in FIG. 3.

Network interface 150 is configured to enable wired and/or wireless communications. The network interface 150 may be configured to communicate data between the threat evaluation device 112 and other devices, systems, or domains. For example, the network interface 150 may include an NFC interface, a Bluetooth® interface, a Zigbee® interface, a Z-wave® interface, a radio-frequency identification (RFID®) interface, a WIFI® interface, a local area network (LAN) interface, a wide area network (WAN) interface, a metropolitan area network (MAN) interface, a personal area network (PAN) interface, a wireless PAN (WPAN) interface, a modem, a switch, and/or a router. The processor 126 may be configured to send and receive data using the network interface 150. The network interface 150 may be configured to use any suitable type of communication protocol.

The memory 128 may be volatile or non-volatile and may comprise read-only memory (ROM), random-access memory (RAM), ternary content-addressable memory (TCAM), dynamic random-access memory (DRAM), and static random-access memory (SRAM). The memory 128 may include one or more of a local database, a cloud database, a network-attached storage (NAS), etc. The memory 128 comprises one or more disks, tape drives, or solid-state drives, and may be used as an over-flow data storage device, to store programs when such programs are selected for execution, and to store instructions and data that are read during program execution. The memory 128 may store any of the information described in FIGS. 1-3 along with any other data, instructions, logic, rules, or code operable to implement the function(s) described herein when executed by processor 126. For example, the memory 128 may store software instructions 130, generative AI model 138, threat metadata 140, threat definitions 142, threat definitions database 146, artificial intelligence algorithm 144 quarantine sector 154, and/or any other data or instructions. The software instructions 130 may include any suitable set of instructions, logic, rules, or code operable to execute the processor 126 and perform the functions described herein, such as some or all of those described in FIGS. 1-3.

### Generative AI model

Generative AI model 138 may be implemented by the processor 126 executing software instructions 130 and is generally configured to create a threat definitions database 146. Threat metadata 140 is input to the generative AI model 138. The generative AI model 138 transforms the input to create threat definitions 142 as output. The generative AI model 138 stores threat metadata 140 and the threat definitions 142 in the threat definitions database 146. In some embodiments, the generative AI model 138 is a trained artificial intelligence (AI) algorithm 144 (e.g., K-means clustering algorithm or any other machine learning algorithm) that is configured to transform the input threat metadata 140 into threat definitions 142 as output. The AI algorithm 144 may include a support vector machine, neural network, random forest, k-means clustering, Tree-based algorithm, Random Forest algorithm, etc. In some embodiments, the AI algorithm 144 may include a data processing AI algorithm that is configured to generate threat definitions database 146. The AI algorithm 144 may be implemented by supervised, semi-supervised, and/or unsupervised machine learning algorithm. For example, the AI algorithm 144 (e.g., K-means clustering algorithm) is implemented to transform the input threat metadata 140 to create the threat definitions 142. Threat metadata 140 is input to the AI algorithm 144. The AI algorithm 144 transforms the input to create threat definitions 142 as output.

### Generating Threat Definitions

Threat evaluation device 112 receives the threat metadata 140 from the web crawler device 110. Processor 126 executes the generative AI model 138 using the received threat metadata 140 as input. By way of example, the received threat metadata 140 may include threat metadata 140a, which is a malicious operation pattern implemented by a malicious software program (e.g., Virus A). Other examples of received threat metadata 140 include information for the source location of the potential virus (e.g., country of origination), identity information of a bad actor (e.g., a known hackers group) that created the potential virus, time frame associated with the release of the potential virus (e.g., a month or year of release), other types of known virus that are associated with the potential virus (e.g., the potential virus partly performs operations related to a Trojan Horse type virus), development stage of the virus (e.g., proof-of-concept stage, developed stage, in process of being developed, etc.), other types of information related to the potential virus may also be included in the threat metadata 140.

The threat metadata 140 may include a malicious operation pattern associated with how a potential virus conducts an attack. Further, malicious operation patterns include one or more steps taken to perform the operation, one or more types of action performed by the attack, one or more types of operating systems targeted by the attack, one or more types of applications targeted by the attack, one or more types of hardware devices targeted by the attack, and/or one or more types of organizations targeted by the attack. Any other type of information may also be included in the threat metadata 140a.

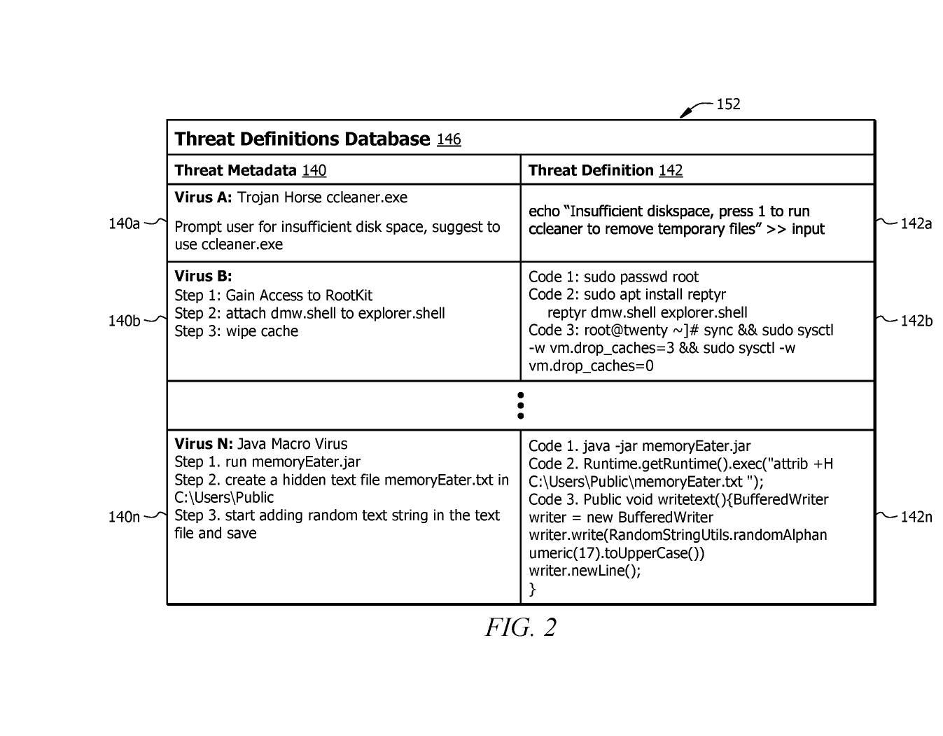

Specifically, the steps taken to perform the malicious operation pattern include a series of steps (e.g., see FIG. 2, threat metadata 140b includes step 1, step 2, step 3). The types of action performed by the attack may include, for example, downloading and installing malicious software on the organizational resources 114 to delete files within the organizational resources 114, gaining administrative access associated with organizational resources 114 to delete files from the organizational resources 114, downloading and installing malicious software on the organizational resources 114 to run multiple high memory consuming tasks to slow processing speeds of the organizational resources 114, SQL injection type attack on the organizational resources 114, any other type of malicious action may also be included.

Further, the types of operating systems targeted by the attack may include, for example, a Windows® operating system, Linux® operating system, Macintosh® operating system, or any other type of operating system associated with the organizational resources 114 may also be included. The types of software applications targeted by the attack may include, for example, e.g., text documents, spreadsheet documents, email software, chat software, social media software, and web browsers, although any other type of software application operating on the organizational resources 114 may also be included. The types of hardware devices targeted by the attack may include, for example, servers, databases, network devices (routers, gateway devices, etc.), and communication devices (audio/video communication devices, fax machines, printers, etc.), although any other type of hardware devices of the organizational resources 114 may also be included. The types of organizations targeted by the attack may include, for example, financial organizations, software companies, government organizations, schools, universities, or any other type of organization.

The generative AI model 138 receives threat metadata 140 (e.g., threat metadata 140a) from the web crawler device 110. When threat metadata 140 is input to the generative AI model 138, the generative AI model 138 creates threat definitions 142 as output. For example, when threat metadata 140a is input to the generative AI model 138, then the output is the threat definition 142a. Threat definitions 142 include an example software code associated with the malicious operation pattern of the malicious software program. For example, threat definition 142a is a software code that corresponds to the malicious operation pattern conducted by Virus A. The generative AI model 138 stores the threat definitions 142 in a threat definitions database 146.

For example, threat definitions 142 may include an example software code that would carry out some or all of the actions planned by the malicious operation pattern included in the threat metadata 140. In particular, as described above, threat metadata 140 includes a malicious operation pattern that includes one or more actions performed by the attack. Accordingly, when the malicious operation pattern of the threat metadata 140 includes an action of downloading and installing malicious software on the organizational resources 114 to delete files within the organizational resources 114, then the threat definitions 142 includes an example software code with instructions that would download and install malicious software on the organizational resources 114 to delete files within the organizational resources 114. Further, when the malicious operation pattern of the threat metadata 140 includes an action of gaining administrative access associated with organizational resources 114 to delete files from the organizational resources 114, then the threat definitions 142 includes an example software code with instructions that would gain administrative access associated with organizational resources 114 to delete files from the organizational resources 114. Additionally, when the malicious operation pattern of the threat metadata 140 includes an action of downloading and installing malicious software on the organizational resources 114 to run multiple high memory-consuming tasks to slow processing speeds of the organizational resources 114, then the threat definitions 142 includes an example software code with instructions that would download and install malicious software on the organizational resources 114 to run multiple high memory consuming tasks to slow processing speeds of the organizational resources 114. Additionally, when the malicious operation pattern of the threat metadata 140 includes an action of an SQL injection type attack on the organizational resources 114, then the threat definitions 142 includes an example software code with instructions that would perform an SQL injection type attack on the organizational resources 114. Further, if a malicious operation pattern is targeting a specific part of the organizational resources 114, then the example software code included instructions that would target the specific part of the organizational resources 114.

Further, with reference to FIG. 2, when threat metadata 140b includes a malicious operation pattern of step 1, step 2, and step 3, then threat definition 142b includes code 1 to implement the operation of step 1, code 2 to implement the operation of step 2, and code 3 to implement the operation of step 3, respectively.

Threat definitions 142 may also be interchangeably referred to as threat detection policies 142.

### Threat definitions database

With reference FIG. 2, threat definitions database 146 includes a table 152 representing the threat metadata 140a-140n and its corresponding threat definitions 142a-142-n. For example, table 152 shows a threat metadata 140a that includes the malicious operation pattern of Virus A was inputted to the generative AI model 138, and the corresponding threat definition 142a was created as the output. The threat definition 142a is the software code associated with the malicious operation pattern of Virus A. In another example, when the generative AI model 138 receives an input of threat metadata 140n that includes the malicious operation pattern of Virus N, then the generative AI model 138 creates threat definition 142n as the output. The threat definition 142n is the software code associated with the malicious operation pattern of Virus N. Once the threat definitions 142 are stored in the threat definitions database 146, the processor 126 scans the organizational resources 114 for malware corresponding to the stored threat definitions 142. Threat definitions database 146 is further described in detail with reference to FIG. 2 below.

### Scanning organizational resources based on the threat definitions and mitigating the identified threat

The processor 126 of the threat evaluation device 112 scans the organizational resources 114 for malware corresponding to the stored threat definitions 142. In response to the scan, the processor 126 identifies that the device 132-1 includes a suspected software program 136, which includes a malicious software code 136a that at least partially matches the software code associated with the malicious operation pattern of Virus A included in the threat definition 142a. Thus, the processor 126 identifies suspected software program 136 as a threat before the malicious software code 136a executes its malicious operation. Upon identifying the suspected software program 136 as a threat, mitigation of the identified threat is performed by quarantining the suspected software program 136 before the suspected software program 136 executes the malicious software code 136a. As part of quarantining the suspected software program 136, the suspected software program 136 is transferred from device 132-1 to quarantine sector 154 within memory 128 of the threat evaluation device 112. For example, the transfer is performed by the processor 126 copying the suspected software program 136 into the quarantine sector 154 and then deleting the suspected software program 136 from the device 132-1 where it was identified. Once the suspected software program 136 is transferred into the quarantine sector 154, the disclosed system mitigates the identified threat by deleting the malicious software code 136a from the suspected software program 136 to generate a sanitized version of the suspected software program 136. The sanitized version of the suspected software program 136 without the malicious software code 136a is then transferred back to device 132-1, where the suspected software program 136 was identified.

The disclosed system thus improves the protection of organizational resources 114 from malware threats by proactively detecting and mitigating malicious software code 136a by physically isolating only the suspected software program 136 identified as a threat). Thus, by quarantining or deleting the malicious software code 136a, the disclosed system allows legitimate software applications on the organizational resources 114 to run without disruptions or interference, and instances of legitimate software applications being infected by the malicious software code 136a are reduced.

In another embodiment, the malicious software code 136a may include a malware, a virus, a trojan horse, a macro virus, a ransomware, a spyware, an adware, a scareware, a rootkit, or a combination thereof.

In another embodiment, upon identifying the suspected software program 136 as a threat, mitigation of the identified threat is performed by deleting the malicious software code 136a from the suspected software program 136 at device 132-1, where it was identified without transferring the suspected software program 136 to the quarantine sector 154. Further, if it is determined the malicious software code cannot be deleted then the suspected software program is quarantined by transferring to the quarantine sector 154 from the device 132-1.

### Example threat definitions database of FIG. 2

FIG. 2 illustrates a threat definitions database 146 of the system 100 of FIG. 1, in accordance with an embodiment of the present disclosure. Threat definitions database 146 includes a table 152 representing the threat metadata 140 and its corresponding threat definitions 142. Specifically, threat metadata 140 is input to the generative AI model 138. The generative AI model 138 creates threat definitions 142 as output. FIG. 2 shows table 152 representing the threat metadata 140a-140n and its corresponding threat definitions 142a-142-n.

### Example threat metadata 140a and threat definition 142a for Virus A

For example, when the generative AI model 138 receives an input of threat metadata 140a that includes the malicious operation pattern of Virus A, then the generative AI model 138 creates threat definition 142a as the output. Threat metadata 140a includes the malicious operation pattern of Virus A. For example, Virus A is a Trojan Horse type of malware. Its malicious operation is to install a malicious software program (e.g., ccleaner.exe) on organizational resources 114, and upon installing the malicious software program, the malicious software program will copy the contents from the organizational resources 114 to an external server associated with a bad actor.

To perform its malicious operation, Virus A would perform the step of “Prompt user for insufficient disk space, suggest to use ccleaner.exe.” This represents the malicious operation pattern of Virus A referred to as threat metadata 140a. When this threat metadata 140a, including the malicious operation pattern, is inputted to the generative AI model 138, then the generative AI model 138 transforms the malicious operation pattern of Virus A to output a software code that corresponds to the malicious operation pattern of Virus A. This software code created by the generative AI model 138 is the threat definition 142a. Accordingly, when the malicious operation pattern of the threat metadata 140a includes an action of prompting a user for insufficient disk space, then the threat definition 142a includes an example software code with instructions that would prompt a user for insufficient disk space. The threat definition 142a is the software code associated with the malicious operation pattern of Virus A. For example, when the threat metadata 140a of “Prompt user for insufficient disk space, suggest to use ccleaner.exe.” is inputted to the generative AI model 138, then generative AI model 138 creates the corresponding threat definition 142a “echo “Insufficient diskspace, press 1 to run ccleaner to remove temporary files” >> input”.

Accordingly, in this example, the input threat metadata 140a comprises a malicious operation pattern that performs an action by Virus A to prompt a user of the organizational resources 114 to install a malicious file (e.g., ccleaner.exe), and the generated threat definition output 142a (as represented in table 152) comprises software code associated with generating a prompt to install the malicious file on the organizational resources 114.

### Example threat metadata 140b and threat definition 142b for Virus B

In another example, when the generative AI model 138 receives an input of threat metadata 140b that includes the malicious operation pattern of Virus B, then the generative AI model 138 creates threat definition 142b as the output. Threat metadata 140b includes the malicious operation pattern of Virus B. For example, the malicious operation of Virus B is to install a malicious software program (e.g., dmv.shell) on organizational resources 114. Upon executing the malicious software program, the malicious software program will gain access to the organizational resources 114 and delete or wipe the data stored in the organizational resources 114.

To perform its malicious operation, Virus B would perform steps 1-3 of threat metadata 140b. For example, steps 1-3 represent the malicious operation pattern of Virus B, referred to as threat metadata 140b. Step 1 is “Gain Access to RootKit”, step 2 is “attach dmw.shell to explorer.shell”, and step 3 is “wipe cache.” When this threat metadata 140b, including the malicious operation pattern of steps 1-3, is input to the generative AI model 138, the generative AI model 138 transforms the operation pattern of steps 1-3 of Virus B to output software code (e.g., code 1, code 2, and code 3 of threat definition 142b) that corresponds to the malicious operation pattern of Virus B. This software code created by the generative AI model 138 is the threat definition 142b. Code 1, code 2, and code 3 each represent the software code corresponding to step 1, step 2, and step 3, respectively, as represented in threat definition 142b of table 152. Code 1 represents the malicious operation of step 1, code 2 represents the malicious operation of step 2, and code 3 represents the malicious operation of step 3.

Accordingly, in this example, the input threat metadata 140b comprises a malicious operation pattern that performs an action by Virus B to delete cache memory of the organizational resources 114, and the generated threat definition output 142b comprises software code associated with deleting cache memory of the organizational resources 114.

### Example threat metadata 140n and threat definition 142n for Virus N

In another example, when the generative AI model 138 receives an input of threat metadata 140n that includes the malicious operation pattern of Virus N, then the generative AI model 138 creates threat definition 142n as the output. Threat metadata 140n includes the malicious operation pattern of Virus N. For example, Virus N is a Java Macro type of malware. Its malicious operation is to run a malicious software program (e.g., memoryEater.jar) on organizational resources 114, and upon executing the malicious software program, the malicious software program will cause organizational resources 114 to be overloaded with malicious tasks such that the organizational resources 114 would fail and stop working.

To perform its malicious operation, Virus N would perform steps 1-3 of threat metadata 140n. For example, steps 1-3 represent the malicious operation pattern of Virus N, referred to as threat metadata 140n. When this threat metadata 140n, including the malicious operation pattern of steps 1-3, is input to the generative AI model 138, the generative AI model 138 transforms the operation pattern of steps 1-3 of Virus N to output software code (e.g., code 1, code 2, and code 3 of threat definition 142n) that corresponds to the malicious operation pattern of Virus N. Code 1, code 2, and code 3 each represent the software code corresponding to step 1, step 2, and step 3, respectively, as represented in threat definition 142n of table 152. Code 1 represents the malicious operation of step 1, code 2 represents the malicious operation of step 2, and code 3 represents the malicious operation of step 3.

In another embodiment, the input threat metadata 140 comprises a malicious operation pattern that performs an action to change the root password of the organizational resources 114, and the generated threat definition output 142b comprises software code associated with changing the root password of the organizational resources 114.

### Example method 300 for detecting and mitigating malware threats by creating threat definitions

FIG. 3 illustrates an example flowchart of a method 300 for detecting and mitigating malware threats by creating threat definitions in accordance with an embodiment of the present disclosure. Method 300 may be performed by the threat evaluation device 112, shown in FIG. 1. Method 300 may include more, fewer, or other operations. For example, operations may be performed in parallel or in any suitable order. While at times it is discussed that the system 100, threat evaluation device 112, organizational resources 114, web crawler device 110, or components of any of thereof perform some operations, any suitable system or components of the system may perform one or more operations of the method 300. For example, one or more operations of method 300 may be implemented, at least in part, in the form of software instructions 130 of FIG. 1, stored on a tangible non-transitory machine-readable medium or tangible non-transitory computer-readable medium (e.g., memory 128 of FIG. 1) that, when run by one or more processors (e.g., processor 126 of FIG. 1) may cause the one or more processors to perform operations 302-314.

Referring to FIG. 3, at operation 302, processor 126 of the threat evaluation device 112 receives threat metadata 140 from web crawler device 110. By way of example, web crawler device 110 collects information by analyzing public Internet, such as websites 148 (e.g., blogs or technical forum discussions) associated with discussions for a new type of malware that may be developed by bad actors and that would, if implemented, present vulnerabilities to organizational resources 114. By way of example, the received threat metadata 140 may include threat metadata 140a, which is a malicious operation pattern implemented by a malicious software program (e.g., Virus A).

At operation 304, processor 126 of the threat evaluation device 112 executes a generative AI model 138 such that threat metadata 140 is input to the generative AI model 138. In response to receiving threat metadata 140 as input, the generative AI model 138 generates threat definitions 142 as output. For example, when threat metadata 140a is input to the generative AI model 138, then the output is the threat definition 142a. For example, threat definition 142a is a software code that corresponds to the malicious operation pattern conducted by Virus A as part of threat metadata 140a. Threat definitions 142 may also be interchangeably referred to as threat detection policies 142.

At operation 306, the generative AI model 138 stores the threat definitions 142 in a threat definitions database 146. Threat definitions database 146 includes a table 152 representing the threat metadata 140a-140n and its corresponding threat definitions 142a-142-n.

At operation 308, processor 126 of the threat evaluation device 112 scans the organizational resources 114 for malware corresponding to the stored threat definitions 142. As part of scanning the organizational resources 114, processor 126 scans each of the devices 132-1 to 132-n and 134-1 to 134-n. For example, device 132-1 is scanned to determine if a malicious software code 136a in a suspected software program 136 at least partially matches the software code associated with the malicious operation pattern associated with Virus A included in the threat definition 142a.

Referring to FIG. 3, at operation 310, processor 126 of the threat evaluation device 112 identifies device 132-1 to include a suspected software program 136. For example, when processor 126 determines that a malicious software code 136a at least partially matches the software code associated with the malicious operation pattern associated with Virus A included in the threat definition 142a, then the suspected software program 136 is identified as a threat. Then method 300 takes the Yes branch and proceeds to operation 312.

However, back to operation 310, when processor 126 determines that a malicious software code 136a in a suspected software program 136 does not match the software code associated with the malicious operation pattern associated with Virus A included in the threat definition 142a, then the suspected software program 136 is not identified as a threat. The method takes the No branch and loops back to operation 308 to continue scanning other organizational resources 114.

At operation 312, processor 126 copies the suspected software program 136 into the quarantine sector 154 and then deletes the suspected software program 136 from the device 132-1 where it was identified. When stored in this quarantine sector 154, suspected software program 136 is not permitted or prevented from performing any operation on files outside the quarantine sector 154. Specifically, the malicious software code 136a, when in the quarantine sector 154 is prevented from performing any write or read actions outside the quarantine sector 154. Thus, the suspected software program 136 isolated in the quarantine sector 154 cannot harm or attack the rest of the components outside the quarantine sector 154. Further, once the suspected software program 136 is transferred into the quarantine sector 154, method 300 proceeds to operation 314.

At operation 314, processor 126 determines if threat mitigation of the identified suspected software program 136 can be performed by deleting the malicious software code 136a from the suspected software program 136. When processor 126 determines that the malicious software code 136a can be deleted, then processor 126 deletes the malicious software code 136a from the suspected software program 136 to generate a sanitized version of the suspected software program 136. Thus, threat mitigation of the identified suspected software program 136 was successful. Method 300 takes the Yes branch and proceeds to operation 316.

At operation 316, processor 126 transfers the sanitized version of the suspected software program 136 without the malicious software code 136a to device 132-1, where the suspected software program 136 was identified. The method 300 ends here.

Going back to operation 314, when processor 126 determines that the malicious software code 136a cannot be deleted or mitigated, then processor 126 determines to continue quarantining the suspected software program 136 at the quarantine sector, the method takes the No branch to operation 318.

At operation 318, after quarantining the suspected software program 136, the method loops back to operation 314 to continue quarantining the suspected software program 136.

### Issue a warning message or notification to a network administrator

Additionally, back at operation 312, when processor 126 determines that threat mitigation of the identified suspected software program 136 can be performed, then processor 126 issues a warning message or notification to a network administrator associated with the organizational resources 114. This issuing a message or notification may include transmitting a message to device 132-n associated with a network administrator of the organization. The message notifies the network administrator that a malware threat or malware attack is detected and is being mitigated. The message may also include information identifying the portion of the malicious software code 136a of suspected software program 136 that is affected by the malware attack and indicates that the malware attack is being mitigated be deleting the malicious software code 136a.

Additionally, back at operation 314, when processor 126 determines that the malicious software code 136a cannot be deleted or mitigated, then processor 126 transmits a message or notification to device 132-n associated with a network administrator of the organization. This message may indicate to the network administrator that a malware attack is detected and the malware attack cannot be mitigated by deleting the malicious software code 136a.

### Proactively searching for threats in multiple organizational resources

In another embodiment, referring back to operation 310, when processor 126 determines that the malicious software code 136a in a suspected software program 136 of device 132-1 is identified as a threat, processor 126 identifies other organizational resources 114 (e.g., device 132-n) that have been in communication with the device 132-1. For example, device 132-1 sends a spam email to device 132-n. In this example, suspected software program 136 is an email application, and the malicious software code 136a is in a file attachment of a spam email sent by device 132-1 to device 132-n. Processor 126 then proactively scans for the malicious software code 136a on device 132-n that received the spam email to identify and mitigate the threat associated with the malicious software code 136a on device 132-n. This provides a technical improvement in proactively searching for evidence of the malware across organizational resources 114 over the current malware detection techniques where the malware would not have been identified before the attack. In this example, although device 132-n is proactively scanned, the spam email could be sent by device 132-1 to multiple other devices as part of organizational resources 114, and the other devices may also be proactively scanned. This example describes an email application. However, any other software program may also be proactively scanned.

### Identifying threats after the execution of malicious software code is initiated and before the execution is completed

In some embodiments, back at operation 310, processor 126 identifies the suspected software program 136 installed on device 132-1 after malicious software code 136a has initiated execution of the malware and before the execution is completed. Then at operation 314, processor 126 determines if threat mitigation of the identified suspected software program 136 can be performed. The method then follows the method as described above from operation 312.

### Scan all communication requests before they reach the organizational resources.

In another embodiment, back at operation 308, processor 126 of the threat evaluation device 112 may scan all communication requests (e.g., incoming requests) directed toward organizational resources 114 before it is received by the organizational resources 114. For example, a request that is directed towards device 132-1 is intercepted by the threat evaluation device 112 and is stored in the quarantine sector 154 before it is received by device 132-1. Processor 126 then performs a scan on the received request to identify if the request includes a software code that at least partially matches the stored threat definitions 142. Based on the scan, if processor 126 determines that the received request includes a suspected software program 136 with a malicious software code 136a that at least partially matches the software code associated with the malicious operation pattern included in the threat definitions 142, then processor 126 deletes that malicious software code 136a and generates a sanitized version of the suspected software program 136 without that malicious software code 136a. Processor 126 then allows transmission of the received request with the sanitized version of the suspected software program 136 to the device 132-1.

In another embodiment, all outgoing requests from the organizational resources 114 may be scanned at threat evaluation device 112, similar to operation 308 explained above for incoming requests.

### Network traffic filtration based on monitoring web threats and network policies

In another embodiment, the web crawler device 110 identifies web threats by crawling the websites 148 to generate web threat metadata. Web threats may include information website information that could be used to perform malicious activities on organizational resources 114. For example, one web threat metadata may be a malicious website with a URL that looks similar to a genuine website. The malicious website may have the URL www.companyname.maliciousindicator.com, whereas a corresponding genuine website may have the URL www.companyname.com. This web threat information is stored as web threat metadata and transmitted by the web crawler device 110 to the threat evaluation device 112. At the threat evaluation device 112, processor 126 executes the generative AI model 138, such that web threat metadata with the web threat information is input to generative AI model 138, and the threat monitoring policies are generated as output. For example, a traffic monitoring policy may be blocking incoming request for websites with the URL of www.companyname.com. These traffic monitoring policies are used to monitor and filter out malicious communications from incoming or outgoing messages to or from organizational resources 114.

While several embodiments have been provided in the present disclosure, it should be understood that the system 100 and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented. In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein. To aid the Patent Office, and any readers of any patent issued on this application in interpreting the claims appended hereto, applicants note that they do not intend any of the appended claims to invoke 35 U.S.C. § 112(f), as it exists on the date of filing hereof, unless the words “means for” or “step for” are explicitly used in the particular claim.

1. A system comprising:
a memory operable to store a generative artificial intelligence (AI) model and a threat definition database; and
a processor operably coupled to the memory and configured to:
receive threat metadata from a web crawler device configured to access one or more websites, wherein the threat metadata is associated with a malicious software program that implements a malicious operation pattern;
execute the generative artificial intelligence (AI) model using the threat metadata as an input, wherein the generative AI model is configured to generate a threat definition as output and store the threat definition in the threat definition database, wherein the threat definition comprises software code associated with the malicious operation pattern of the malicious software program;
perform a scan of one or more organizational resources based on the stored threat definition;
identify, based on the scan, a threat associated with a suspected software program before it executes a malicious software code on the one or more organizational resources, wherein the malicious software code of the suspected software program at least partially matches the software code of the threat definition; and
mitigate the identified threat by quarantining the suspected software program before it executes the malicious software code on the one or more organizational resources.

2. The system of claim 1, wherein the processor further executes the generative AI model to:
mitigate the identified threat by deleting the malicious software code from the suspected software program before the suspected software program executes the malicious software code on the one or more organizational resources.

3. The system of claim 1, wherein the malicious software program comprises a malware, a virus, a trojan horse, a macro virus, a ransomware, a spyware, an adware, a scareware, a rootkit, or a combination thereof.

4. The system of claim 1, wherein the processor is configured to store an AI algorithm, and the processor is configured to:
execute the AI algorithm using the threat metadata as the input; and
generate the threat definition as the output, by transforming the input threat metadata into the software code associated with the malicious operation pattern.

5. The system of claim 4, wherein the input threat metadata comprises an action performed by a virus to delete cache memory of the one or more organizational resources, and the generated threat definition output comprises software code associated with deleting the cache memory of the one or more organizational resources.

6. The system of claim 4, wherein the input threat metadata comprises a virus prompting a user of the one or more organizational resources to install a malicious file, and the generated threat definition output comprises software code that generates the prompt to install the malicious file.

7. The system of claim 1, wherein the processor is configured to:
issue a warning message, when the identified threat cannot be mitigated, to a device associated with the one or more organizational resources.

8. A method comprising:
receiving threat metadata from a web crawler device configured to access one or more websites, wherein the threat metadata is associated with a malicious software program that implements a malicious operation pattern;
executing a generative artificial intelligence (AI) model using the threat metadata as an input, wherein the generative AI model is configured to generate a threat definition as output and store the threat definition in a threat definition database, wherein the threat definition comprises software code associated with the malicious operation pattern of the malicious software program;
performing a scan of one or more organizational resources based on the stored threat definition;
identifying, based on the scan, a threat associated with a suspected software program before it executes a malicious software code on the one or more organizational resources, wherein the malicious software code of the suspected software program at least partially matches the software code of the threat definition; and
mitigating the identified threat by quarantining the suspected software program before it executes the malicious software code on the one or more organizational resources.

9. The method of claim 8, further comprising:
mitigating the identified threat by deleting the malicious software code from the suspected software program before the suspected software program executes the malicious software code on the one or more organizational resources.

10. The method of claim 8, wherein the malicious software program comprises a malware, a virus, a trojan horse, a macro virus, a ransomware, a spyware, an adware, a scareware, a rootkit, or a combination thereof.

11. The method of claim 8, further comprising:
executing an AI algorithm using the threat metadata as the input; and
generating the threat definition as the output, by transforming the input threat metadata into the software code associated with the malicious operation pattern.

12. The method of claim 11, wherein the input threat metadata comprises an action performed by a virus to delete cache memory of the one or more organizational resources, and the generated threat definition output comprises software code associated with deleting the cache memory of the one or more organizational resources.

13. The method of claim 11, wherein the input threat metadata comprises a virus prompting a user of the one or more organizational resources to install a malicious file, and the generated threat definition output comprises software code that generates the prompt to install the malicious file.

14. The method of claim 8, further comprising:
issuing a warning message, when the identified threat cannot be mitigated, to a device associated with the one or more organizational resources.

15. A non-transitory computer-readable medium storing instructions that, when executed by a processor, cause the processor to:
receive threat metadata from a web crawler device configured to access one or more websites, wherein the threat metadata is associated with a malicious software program that implements a malicious operation pattern;
execute a generative artificial intelligence (AI) model using the threat metadata as an input, wherein the generative AI model is configured to generate a threat definition as output and store the threat definition in a threat definition database, wherein the threat definition comprises software code associated with the malicious operation pattern of the malicious software program;
perform a scan of one or more organizational resources based on the stored threat definition;
identify, based on the scan, a threat associated with a suspected software program before it executes a malicious software code on the one or more organizational resources, wherein the malicious software code of the suspected software program at least partially matches the software code of the threat definition; and
mitigate the identified threat by quarantining the suspected software program before it executes the malicious software code on the one or more organizational resources.

16. The non-transitory computer-readable medium of claim 15, wherein the instructions further cause the processor to:
mitigate the identified threat by deleting the malicious software code from the suspected software program before the suspected software program executes the malicious software code on the one or more organizational resources.

17. The non-transitory computer-readable medium of claim 15, wherein the malicious software program comprises a malware, a virus, a trojan horse, a macro virus, a ransomware, a spyware, an adware, a scareware, a rootkit, or a combination thereof.

18. The non-transitory computer-readable medium of claim 15, wherein the instructions further cause the processor to:
execute an AI algorithm using the threat metadata as the input; and
generate the threat definition as the output, by transforming the input threat metadata into the software code associated with the malicious operation pattern.

19. The non-transitory computer-readable medium of claim 18, wherein the input threat metadata comprises an action performed by a virus to delete cache memory of the one or more organizational resources, and the generated threat definition output comprises software code associated with deleting the cache memory of the one or more organizational resources.

20. The non-transitory computer-readable medium of claim 18, wherein the input threat metadata comprises a virus prompting a user of the one or more organizational resources to install a malicious file, and the generated threat definition output comprises software code that generates the prompt to install the malicious file.
